(19) United States
(12) Patent Application Publication
(10) Pub. No.: US 2026/0359474 A1
(43) Pub. Date: Nov. 12, 2026

(54) ELECTRONIC APPARATUS AND METHODS FOR SECURITY AND PRIVACY PRESERVING AGENTIC MONITORING IN EDGE DEVICES

(71) Applicant: Samsung Electronics Co., Ltd., Suwon-si (KR)

(72) Inventors: Sagar Mahesh MALIYE, Bengaluru (IN); Nikhil SAHNI, Bengaluru (IN); Renju Chirakarotu NAIR, Bengaluru (IN); Shashidhara RAMACHANDRAPPA, Bengaluru (IN); Sreevatsa Dwaraka BHAMIDIPATI, Bengaluru (IN); Aarif ZAFAR, Bengaluru (IN); Harsh Bhushan TALELE, Bengaluru (IN)

(21) Appl. No.: 19/649,785

(22) Filed: Apr. 16, 2026

Related U.S. Application Data
(63) Continuation of application No. PCT/IB2026/051638, filed on Feb. 20, 2026.

(30) Foreign Application Priority Data
May 12, 2025 (IN) 202541045639
Jul. 15, 2025 (IN) 2025 41045639

(51) Int. Cl. G06F 21/62; G06N 5/045; H04L 9/32

(52) U.S. Cl. CPC G06F 21/6245; G06N 5/045; H04L 9/3218

(57) ABSTRACT

An electronic apparatus and methods for security and privacy preserving agentic monitoring in edge devices are provided. The method includes providing, by an agentic monitoring framework, and a privacy and security agent, an authorized agentic access, personal identifiable information (PII) cleared data transfers, knowledge graph based task outputs, user explainability, and ethical/sensitivity reasoning, ensuring authorized access to device resources, and user data via levelled security mechanisms, agents authentication via a zero-knowledge proof (ZKP), and a task based authentication, and providing user explainability in case of actions related to blocked agentic access.

### CROSS-REFERENCE TO RELATED APPLICATION(S)

This application is a continuation application, claiming priority under 35 U.S.C. § 365 (c), of an International application No. PCT/IB2026/051638, filed on Feb. 20, 2026, which is based on and claims the benefit of an Indian Provisional application No. 202541045639, filed on May 12, 2025, in the Indian Intellectual Property Office, and of an Indian Complete patent application No. 202541045639, filed on Jul. 15, 2025, in the Indian Intellectual Property Office, the disclosure of each of which is incorporated by reference herein in its entirety.

### BACKGROUND

### 1. Field

The disclosure relates to security methods and systems. More particularly, the disclosure relates to electronic apparatus and methods for security and privacy preserving agentic monitoring in edge devices.

### 2. Description of Related Art

Currently, electronic apparatuses, such as smartphones or the like having artificial intelligence (AI) agents is quite useful for users, as the AI agents having multimodal capabilities make interactions, and tasks completions easy and smooth for the user. However, as various service providers are supporting in creation of AI agents, and deployment easy for third party applications (or apps) and users, there currently not much focus on the side effects, and security vulnerabilities of these AI agents. The AI agents are powerful entities, hence a mechanism may be needed which monitors, and effectively prevents over-reach and unrestricted access by different AI agents. Since the electronic apparatus can be used for many purposes by the user, any privacy breach and data/device security issues may have far reaching effects, hence a proactive monitoring and protection mechanism is mandatory and unavoidable in latest edge devices.

There is currently no effective solution which can ensure that the deployed AI agents, though having a vast reach and capability, can work within proper guidelines and perform expected functionalities only, without accessing any extraneous and irrelevant resources, data, and so on.

In other words, the issue is arising as the AI agents are deployed on the device with multimodal capabilities. The AI agents can be used for all activities including social media, banking operations, travel bookings, net browsing, health/fitness tracking, and so on. Hence, the AI agents have access to all resources and User's data on the device, as well as to external resources and internet through their tools and extensions. Since, the third party agents also can be easily added onto the devices, it needs to be ensured that there is no improper usage by the agents with respect to data access, privacy breaching, security vulnerabilities exploitation, and so on. The deployment of the AI agents on the devices, and their regular usage for any tasks may lead to the problem of over-reach, and unrestricted access while performing the tasks.

Below are the impact/harm caused to existing systems:
a) User's personal data may be easily accessible to the AI agents and they may use and share it even if irrelevant to their assigned task.
b) External accesses by the AI agents may leave the device vulnerable to breaches, attacks and exposure/leakage of information.
c) There are multiple security vulnerabilities with AI agents currently, which include unpredictability of multi-step user inputs, complexity in internal executions, variability of operational environments, interactions with untrusted external entities, unauthorised internet access, or the like.

For example, in latest smartphones, AI is an integral part of a plurality of features provided to the user. The user may expect different tasks to be completed by just one click of a device (for example, electronic apparatus), or even by singular voice commands. In latest electronic apparatuses, the AI agents with multimodal capabilities are a major unique selling point (USP) feature, and other service provider (for example, Google, Qualcomm, or the like) too provides an agentic framework support for different third party developers to create their own AI agents.

In such an environment, it becomes vital that the user's privacy and device security is protected and the AI agents present on device be monitored for proper usage given their vast reach and capabilities.

Further, the current device ecosystem does not provide the user with any inbuilt framework for handling different types of tasks, providing insights, handling security of the device, and so on. A research and advisory firm (for example, Gartner) mentions multiple security concerns with AI agents, as listed below. Below are the risks with AI Agents:
a) Chain of events and interactions need to be overseen,
b) May lead to data exposure,
c) Privacy breaches, and
d) May cause denial of service due to resources being unavailable.

The AI agents, though capable of providing multimodality support and diverse functionality, the AI Agents have their share of issues, which are listed below.
a) Unpredictability of multi-step user inputs
   Poorly defined inputs can trigger a chain of unwanted responses, sometimes with serious consequences. Additionally, malicious users may deliberately prompt AI agents to perform unsafe actions or execute harmful code.
b) Complexity in internal executions
   The internal execution state of an AI agent involves a complex sequence of processes, including prompt reformatting, task planning by large language models (LLMs), and the use of various tools.
   Much of this internal execution is implicit and not readily observable, making it challenging to track these operations in real time. Hence, the risk of security vulnerabilities going undetected increases.
c) Variability of operational environments
   AI agents often operate across different environments which continue to become more variable and challenging. This can lead to possible inconsistent behaviour and outcomes.
d) Interactions with untrusted external entities
   AI agents use tools and interact with other agents and external systems.
   This process typically assumes that external entities are trusted, creating vulnerabilities and exposing AI agents to various attack vectors, such as indirect prompt injection attacks.
e) Data privacy breaches, unauthorized access to sensitive data
   Unsupervised AI agent may end up accessing and sharing sensitive and private data due to improperly created sub-tasks, improper access by tools, or malicious breaches intended to pry out private information.
f) Unauthorised Internet resources access, creating false analogies
   Unsupervised AI agent may end up accessing multiple resources via internet and create false scenarios/analogies to get the task completed even though it is not allowed to
   In an example, a chat-bot accessing internet and outsourcing on-device tasks externally via different websites

It is desired to address the above mentioned disadvantages or other shortcomings or at least provide a useful alternative.

Hence, there is a need in the art for solutions which will overcome the above mentioned drawback(s), among others.

The above information is presented as background information only to assist with an understanding of the disclosure. No determination has been made, and no assertion is made, as to whether any of the above might be applicable as prior art with regard to the disclosure,

### SUMMARY

Aspects of the disclosure are to address at least the above-mentioned problems and/or disadvantages and to provide at least the advantages described below. Accordingly, an aspect of the disclosure is to provide an electronic apparatus and methods for security and privacy preserving agentic monitoring in edge devices.

Another aspect of the disclosure is to provide an electronic apparatus and methods for providing an agentic monitoring framework, and a privacy and security agent which provides an authorized agentic access, personal identifiable information (PII) cleared data transfers, knowledge graph based task outputs, user explainability, and ethical/sensitivity reasoning.

Another aspect of the disclosure is to provide an electronic apparatus and methods for protecting the security and privacy of the user, and device for artificial intelligence (AI) agents which might purposely or inadvertently access and leak personal information and/or compromise security of the device.

Another aspect of the disclosure is to provide an electronic apparatus and methods for ensuring only authorized access to device resources and user data via levelled security mechanisms.

Another aspect of the disclosure is to provide an electronic apparatus and methods for providing agents authentication via a zero-knowledge proof (ZKP), and a task based authentication.

Another aspect of the disclosure is to provide an electronic apparatus and methods for providing user explainability in case of actions related to blocked agentic access, and so on.

Additional aspects will be set forth in part in the description which follows and, in part, will be apparent from the description, or may be learned by practice of the presented embodiments.

In accordance with an aspect of the disclosure, a method for managing privacy and security in an edge device is provided. The method includes collecting, by an agent monitoring module of an electronic apparatus, at least one of context and data related to at least one of the electronic apparatus, and one or more devices connected to the electronic apparatus, monitoring, by the agent monitoring module, at least one task being performed by at least one agent, allocating, by the agent monitoring module, one or more tasks to a plurality of agents based on at least one of the collected context and data, and the monitored task being performed by the agent, and connecting, by the agent monitoring module, a privacy and security agent with the plurality of agents for performing one or more allocated tasks of the electronic apparatus, wherein the privacy and security agent is configured to interact with the plurality of agents for performing at least one of an agent authentication, a task authentication, a security level clearance, a personal identifiable information (PII) clearance, a thought reasoning, a knowledge graph reaffirmation, and a user explainability for the tasks to be executed with privacy and security.

In accordance with another aspect of the disclosure, an electronic apparatus is provided. The electronic apparatus includes at least one processor, memory, including one or more storage media, storing instructions, and an agent monitoring module communicatively coupled to the at least one processor and the memory, wherein the instructions, when executed by the at least one processor individually or collectively, cause the electronic apparatus to collect at least one of context and data related to at least one of the electronic apparatus, and one or more devices connected to the electronic apparatus, monitor at least one task being performed by at least one agent, allocate one or more tasks to a plurality of agents based on at least one of the collected at least one of context and data, and at least one monitored task being performed by the agent, connect a privacy and security agent with the plurality of agents for performing one or more allocated tasks of the electronic apparatus, wherein the privacy and security agent is configured to interact with the plurality of agents for performing at least one of an agent authentication, a task authentication, a security level clearance, a personal identifiable information (PII) clearance, a thought reasoning, a knowledge graph reaffirmation, and a user explainability for the one or more tasks to be executed with privacy and security.

In accordance with another aspect of the disclosure, one or more non-transitory computer-readable storage media storing one or more computer programs including computer-executable instructions that, when executed by at least one processor of an audio output apparatus individually or collectively, cause the audio output apparatus to perform operations are provided. The operations include collecting, by an agent monitoring module of an electronic apparatus, at least one of context and data related to at least one of the electronic apparatus, and one or more devices connected to the electronic apparatus, monitoring, by the agent monitoring module, at least one task being performed by at least one agent, allocating, by the agent monitoring module, one or more tasks to a plurality of agents based on at least one of the collected at least one of context and data, and the at least one monitored task being performed by the at least one agent, and connecting, by the agent monitoring module, a privacy and security agent with the plurality of agents for performing the one or more allocated tasks of the electronic apparatus, wherein the privacy and security agent is configured to interact with the plurality of agents for performing at least one of an agent authentication, a task authentication, a security level clearance, a personal identifiable information (PII) clearance, a thought reasoning, a knowledge graph reaffirmation, and a user explainability for the one or more tasks to be executed with privacy and security.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a block diagram of an electronic apparatus for managing privacy and security in edge devices according to an embodiment of the disclosure;

FIG. 2 illustrates a block diagram of an agent monitoring module according to an embodiment of the disclosure;

FIG. 3 illustrates a method for managing privacy and security in an edge device according to an embodiment of the disclosure;

FIG. 4 illustrates a block diagram of at least one agent, and a privacy and security agent, according to an embodiment of the disclosure;

FIG. 5 illustrates a diagram of responsibilities of a privacy and security agent according to an embodiment of the disclosure;

FIG. 6 illustrates a flow diagram of a task execution flow performed by a privacy and security agent according to an embodiment of the disclosure;

FIG. 7A illustrates a process for ZKP authentication between a privacy and security agent and other agents according to an embodiment of the disclosure;

FIG. 7B illustrates agent authentication operations according to an embodiment of the disclosure;

FIG. 8 illustrates a proposed ZKP System without trusted-setup according to an embodiment of the disclosure;

FIG. 9 illustrates a use case of an agent unbounded internet resource access according to an embodiment of the disclosure;

FIG. 10 illustrates a use case of a situation based pop-up attack blocking according to an embodiment of the disclosure;

FIG. 11 illustrates a use case of an agentic interaction for auto-payment according to an embodiment of the disclosure;

FIG. 12 illustrates a use case of a situation based agent co-ordination according to an embodiment of the disclosure;

FIG. 13 illustrates a use case of a situation based agent authentication and blocking according to an embodiment of the disclosure; and

FIG. 14 illustrates a use case of an agent authentication failure according to an embodiment of the disclosure.

Throughout the drawings, like reference numerals will be understood to refer to like parts, components, and structures.

### MODE FOR INVENTION

The following description with reference to the accompanying drawings is provided to assist in a comprehensive understanding various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits, such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports, such as printed circuit boards, and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by symbols of the related art, and the drawings may show only those specific details that are pertinent to understanding the disclosure so as not to obscure the drawings with details that will be readily apparent to those of ordinary skill in the art having the benefit of the description herein. Furthermore, in terms of the system, one or more components/modules which comprise the system may have been represented in the drawings by symbols of the related art, and the drawings may show only those specific details that are pertinent to understanding the disclosure so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words, such as first, second, third, or the like, to describe components/elements/steps is for the purposes of this description and should not be construed as sequential ordering/placement/occurrence unless specified otherwise.

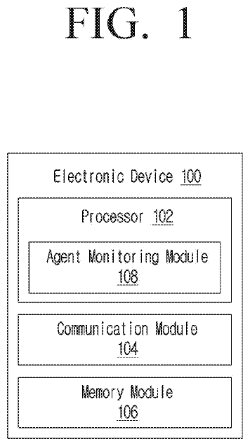

The embodiments herein disclose an electronic apparatus and methods for safeguarding the security, and privacy of a user's data and device by an agentic monitoring framework, and a security and privacy agent by providing an authorized agentic access, personal identifiable information (PII) cleared data transfers, knowledge graph based task outputs, user explainability, and ethical/sensitivity reasoning. Referring now to the drawings, and more particularly to FIGS. 1 to 6, 7A, 7B, and 8 to 14, where similar reference characters denote corresponding features consistently throughout the figures, there are shown embodiments.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

FIG. 1 illustrates a block diagram of an electronic apparatus for managing privacy and security in edge devices according to an embodiment of the disclosure.

Referring to FIG. 1, the edge devices can include, but not limited to smartphones, tabs, smartwatches, televisions, and so on. An electronic apparatus 100 comprises a processor 102, a communication module 104, and memory module 106. In an embodiment of the disclosure, the processor 102 comprises an agent monitoring module 108.

In an embodiment of the disclosure, the agent monitoring module 108 can collect at least one of context and data related to at least one of the electronic apparatus 100, and one or more other electronic apparatuses or devices connected to the electronic apparatus 100. The context of at least one of the electronic apparatus 100, and one or more devices connected to the electronic apparatus 100 is collected from at least one of multimodal activities, application behavior, a user behavior, and a connected devices interaction. The data of at least one of the electronic apparatus 100, and one or more devices connected to the electronic apparatus 100 can include, but not limited to permission, usage stats, resources stats, network stats, accessibility stats, and device security.

In an embodiment of the disclosure, the agent monitoring module 108 can monitor at least one task being performed by at least one agent. The agent monitoring module 108 can allocate one or more tasks to a plurality of agents based on at least one of the collected context and data, and the monitored task being performed by the agent. The agent monitoring module 108 can connect a privacy and security agent with the plurality of agents for performing the allocated tasks of the electronic apparatus 100.

In an embodiment of the disclosure, the agent monitoring module 108 can separate the privacy and security agent, and the plurality of agents into one or more levels, based on at least one of criticality, and functionality of the tasks being performed. The agents can include, but not limited to at least one of a data aggregation and analytics agent, a secure multi-modal interaction agent, a connected systems integration agent, a contextual awareness agent, a resource optimization agent, a task automation agent, a health and wellness agent, and one or more customizable/add-on agents.

In an embodiment of the disclosure, the agent monitoring module 108 sets one or more security levels for the plurality of agents. The agent monitoring module 108 sets security levels, such as low, and high.

In an embodiment of the disclosure, the privacy and security agent can interact with the plurality of agents for performing at least one of an agent authentication, a task authentication, a security level clearance, a PII clearance, a thought reasoning, a knowledge graph reaffirmation, and a user explainability for the tasks to be executed with privacy and security.

In an embodiment of the disclosure, the privacy and security agent can authenticate at least one agent through a zero-knowledge proof (ZKP) protocol for performing the agent authentication, and the agent can mutually authenticate the privacy and security agent as well, on receiving at least one task corresponding to the agent. The ZKP protocol is a modified or a new protocol. The ZKP protocol can use crypto proofs for allowing the plurality of agents to adjust a level of complexity for one or more ZK proofs based on one or more security levels, and manage a session lifetime and ZK proof expiration using an Artificial Intelligence (AI) agent.

In an embodiment of the disclosure, the privacy and security agent can authenticate one or more sub-tasks for performing the task authentication, after authenticating at least one agent. For example, agent that is responsible for at least one task can convert the task into one or more sub-tasks. In an embodiment of the disclosure, the privacy and security agent can collaborate with one or more authenticated agents for obtaining information related to the sub-tasks. The information related to the sub-tasks can include, but not limited to resources, accesses, data, tools, and extensions being used by the plurality of agents for execution. The privacy and security agent can correlate objective of each sub-task with the obtained information related to the sub-tasks. The privacy and security agent can authenticate the converted sub-tasks based on the correlated objective of each sub-task.

In an embodiment of the disclosure, the privacy and security agent can verify a security level of the authenticated agent for performing the security level clearance for the task, and confirm if the agent has the security level clearance for performing the task. The security levels are assigned for each agent by the agent monitoring module 108 depending on criticality of the task being performed for blocking the agent with a lower security level from accessing critical information.

In an embodiment of the disclosure, the privacy and security agent can verify the PII clearance of each sub-task before sending output of each sub-task to at least one of outside of the electronic apparatus 100, and next sub-task and the plurality of agents on the electronic apparatus 100. The output of each sub-task is allowed when the PII is verified as necessary. The privacy and security agent can decide on usage of data related to ethical and sensitivity usage of the authenticated agent, and the verified PII clearance, using a thought reasoning model. The privacy and security agent can validate, and reaffirm the obtained output of each sub-task using an on-device knowledge graph after deciding on usage of data related to ethical and sensitivity usage. The on-device knowledge graph can include, but not limited to information related to security vulnerabilities, domain specific information, and external accesses misuse information. The privacy and security agent can execute and share the validated and reaffirmed output to the user.

In an embodiment of the disclosure, the privacy and security agent can perform the user explainability by explaining to a user on one or more failed tasks, and one or more reasons for the failed tasks.

In an embodiment of the disclosure, the processor 102 can process and execute data of a plurality of modules of the electronic apparatus 100. The processor 102 can be configured to execute instructions stored in the memory module 106. The processor 102 may comprise one or more of microprocessors, circuits, and other hardware configured for processing. The processor 102 can be at least one of a single processer, a plurality of processors, multiple homogeneous or heterogeneous cores, multiple central processing units (CPUs) of different kinds, microcontrollers, special media, and other accelerators. The processor 102 may be an application processor (AP), a graphics-only processing unit (such as a graphics processing unit (GPU), a visual processing unit (VPU)), and/or an artificial intelligence (AI)-dedicated processor (such as a neural processing unit (NPU)).

In an embodiment of the disclosure, the plurality of modules of the processor 102 of the electronic apparatus 100 can communicate via the communication module 104. The communication module 104 may be in the form of either a wired network or a wireless communication network module. The wireless communication network may comprise, but not limited to, global positioning system (GPS), global system for mobile communications (GSM), Wi-Fi, Bluetooth low energy, near-field communication (NFC), and so on. The wireless communication may further comprise one or more of Bluetooth, ZigBee, a short-range wireless communication (such as ultra-wideband (UWB)), and a medium-range wireless communication (such as Wi-Fi) or a long-range wireless communication (such as third generation (3G)/fourth generation (4G)/fifth generation (5G)/sixth generation (6G) and non-third generation partnership project (3GPP) technologies or worldwide interoperability for microwave access (WiMAX)), according to the usage environment.

In an embodiment of the disclosure, the memory module 106 may comprise one or more volatile and non-volatile memory components which are capable of storing data and instructions of the modules of the electronic apparatus 100 to be executed. Examples of the memory module 106 can be, but not limited to, NAND, embedded multi media card (eMMC), secure digital (SD) cards, universal serial bus (USB), serial advanced technology attachment (SATA), solid-state drive (SSD), and so on. The memory module 106 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 106 may, in some examples, be considered a non-transitory storage medium. The term “non-transitory” may indicate that the storage medium is not embodied in a carrier wave or a propagated signal. However, the term “non-transitory” should not be interpreted to mean that the memory module 106 is non-movable. In certain examples, a non-transitory storage medium may store data that can, over time, change (for example, in random access memory (RAM) or cache).

FIG. 1 illustrates modules of an electronic apparatus, but it is to be understood that other embodiments are not limited thereon. In other embodiments of the disclosure, the electronic apparatus 100 may include less or more number of modules. Further, the labels or names of the modules are used only for illustrative purpose and does not limit the scope of the disclosure. One or more modules can be combined together to perform same or substantially similar function in the electronic apparatus 100.

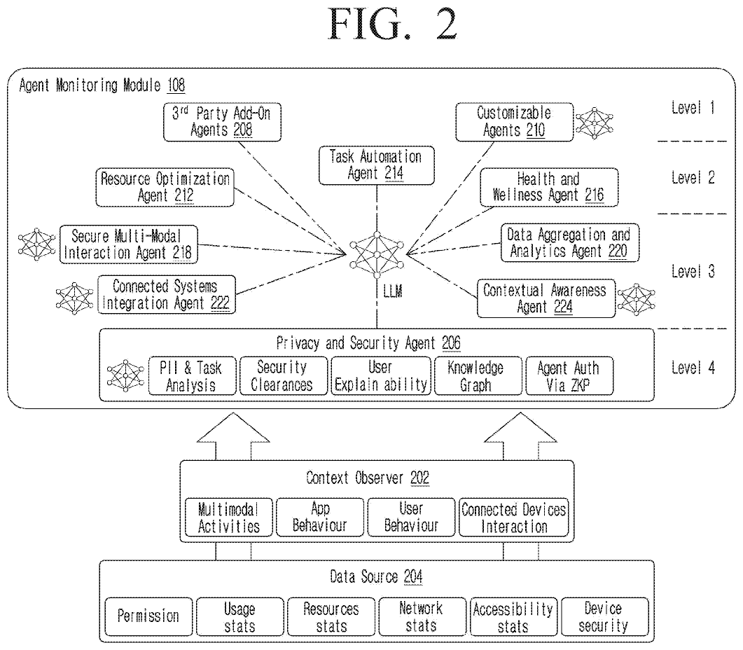

FIG. 2 illustrates a block diagram of an agent monitoring module according to an embodiment of the disclosure.

Referring to FIG. 2, the agent monitoring module 108 involves multiple specialized agents that work together to enhance functionality, deliver more intelligent, and responsive experiences for users. The agent monitoring module 108 collects context related to the electronic apparatus 100, and devices connected to the electronic apparatus 100 from a context observer 202. For example, the context observer 202 includes multimodal activities, app behaviour, user behavior, and connected devices interaction.

The agent monitoring module 108 also collects data related to the electronic apparatus 100, and devices connected to the electronic apparatus 100 from a data source 204. For example, the data source 204 includes permission, usage stats, resources stats, network stats, accessibility stats, and device security.

The agent monitoring module 108 separates the privacy and security agent 206, and the plurality of agents into one or more levels, based on at least one of criticality, and functionality of the tasks being performed. For example, level 1 includes the 3rd party add-on agents 208, and customizable agents 210. Level 2 includes the resource optimization agent 212, the task automation agent 214, and the health and wellness agent 216. Level 3 includes the secure multi-modal interaction agent 218, the data aggregation and analytics agent 220, the connected systems integration agent 222, and the contextual awareness agent 224. Level 4 includes the privacy and security agent 206.

For example, the privacy and security agent 206 manages permissions, monitors for suspicious activity, and ensures data encryption to protect user privacy. The privacy and security agent 206 is the core component of the monitoring framework, and is responsible for agent/task authentication/analysis, PII/security clearances, knowledge graph reaffirmation, user explainability, and agent authentication via ZKP. The privacy and security agent 206 interacts with other agents on device, for example through a large language model (LLM) to ensure security and privacy preservation, and authorized task actions being performed.

In an embodiment of the disclosure, the data aggregation and analytics agent 220 can collect, and analyze security and privacy data from various sources to provide insights or power other agents to take decisions.

In an embodiment of the disclosure, the secure multi-modal interaction agent 218 can coordinate between different input/output modalities, such as voice, touch, and gesture securely.

In an embodiment of the disclosure, the connected systems integration agent 222 can manage, and facilitate interactions with devices, wearables, and other connected systems.

In an embodiment of the disclosure, the contextual awareness agent 224 can detect, and interpret user context, such as location, time, activity, and device status to adapt an application behavior accordingly.

In an embodiment of the disclosure, the resource optimization agent 212 can monitor, and manage battery, memory, and CPU usage to optimize device performance and prolong battery life.

In an embodiment of the disclosure, the health and wellness agent 216 can track health metrics, provide reminders, and suggest wellness activities.

In an embodiment of the disclosure, the 3rd party add-on agents 208, and customizable agents 210 are modifiable agents introduced by user or other 3rd party apps installed on device.

These agents work in harmony under the AI agentic framework of the agent monitoring module 108, which dynamically allocates tasks based on current context. For instance, the contextual awareness agent 224 could trigger the task automation agent 214 to mute notifications in a meeting, while the privacy and security agent 206 ensures sensitive data remains protected during interactions with other apps and no unauthorized accesses happen. If any third party agent output does not comply with PII guidelines or conflicts with knowledge graph reaffirmation, then with user explainability, the blocking action is explained to the user.

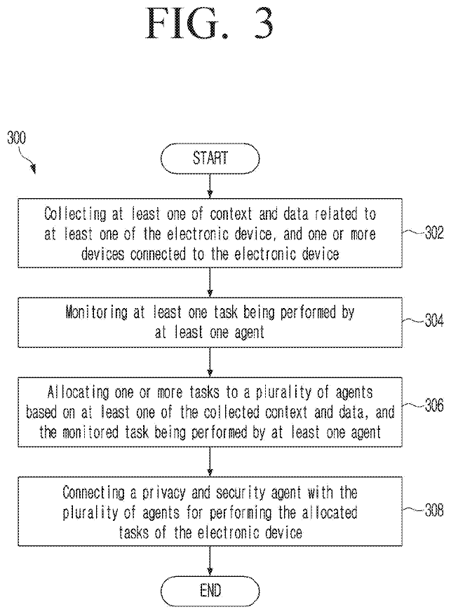

FIG. 3 illustrates a method 300 for managing privacy and security in an edge device according to an embodiment of the disclosure.

Referring to FIG. 3, the method 300 includes collecting, by the agent monitoring module 108 of the electronic apparatus 100, at least one of context and data related to at least one of the electronic apparatus 100, and one or more devices connected to the electronic apparatus 100, as depicted in operation 302. The method 300 comprises monitoring, by the agent monitoring module 108, at least one task being performed by at least one agent, as depicted in operation 304.

Thereafter, the method 300 comprises allocating, by the agent monitoring module 108, one or more tasks to a plurality of agents based on at least one of the collected context and data, and the monitored task being performed by at least one agent, as depicted in operation 306. The method 300 comprises connecting, by the agent monitoring module 108, the privacy and security agent 206 with the plurality of agents for performing one or more allocated tasks of the electronic apparatus 100, as depicted in operation 308. The privacy and security agent 206 can interact with the plurality of agents for performing at least one of the agent authentication, the task authentication, the security level clearance, the PII clearance, the thought reasoning, the knowledge graph reaffirmation, and the user explainability for the tasks to be executed with privacy and security.

The various actions in method 300 may be performed in the order presented, in a different order or simultaneously. Further, in some embodiments of the disclosure, some actions listed in FIG. 3 may be omitted.

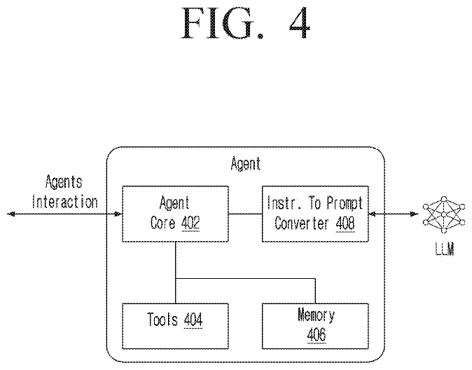

FIG. 4 illustrates a block diagram of at least one agent and a privacy and security agent according to an embodiment of the disclosure.

Referring to FIG. 4, the agent may comprise an agent core 402, one or more tools 404, memory 406, and instructions to prompt convertor 408. The agent core 402 can plan and execute for desired outcome and functionality, handle all internal modules efficiently, and authenticate and collaborate with other agents. The tools 404 can access a database (not shown) for latest information, search, settings access, and so on, and split complex task and create sub-tasks from it. The memory 406 can store past interactions and decisions (for example, accessible only to that agent), and learn from previous outcomes. The instructions to prompt convertor 408 can interface for agentic use of LLM.

In an embodiment of the disclosure, each agent may additionally associate with one or more machine learning (ML) models for performing required functionality.

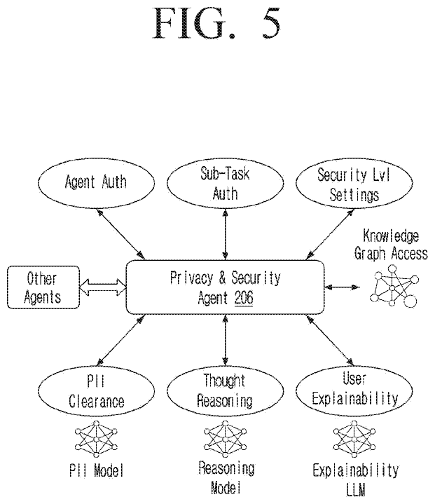

FIG. 5 illustrates a diagram of responsibilities of a privacy and security agent according to an embodiment of the disclosure.

Referring to FIG. 5, the privacy and security agent 206 can authenticate other agents via novel ZKP, and create secure communication channel for further interaction. The privacy and security agent 206 can authenticate agentic tasks/sub-tasks, and resource/data accesses used for the tasks. The privacy and security agent 206 can ensure no PII shared/leaked as part of task outputs by usage of PII model. The privacy and security agent 206 can process information through a thought reasoning model for ethical/sensitivity reasoning for sub-task processing. The privacy and security agent 206 can query for specific domain information from different agents' tasks via knowledge graph reaffirmation. The privacy and security agent 206 can provide explainability to the user with reasons for the taken action for agentic action blocking. The knowledge graph allows storing sensitive data, manages historical security vulnerabilities and misused information, manages information regarding external systems access, and allows the privacy and security agent 206 to refer to knowledge graph for validation of decision.

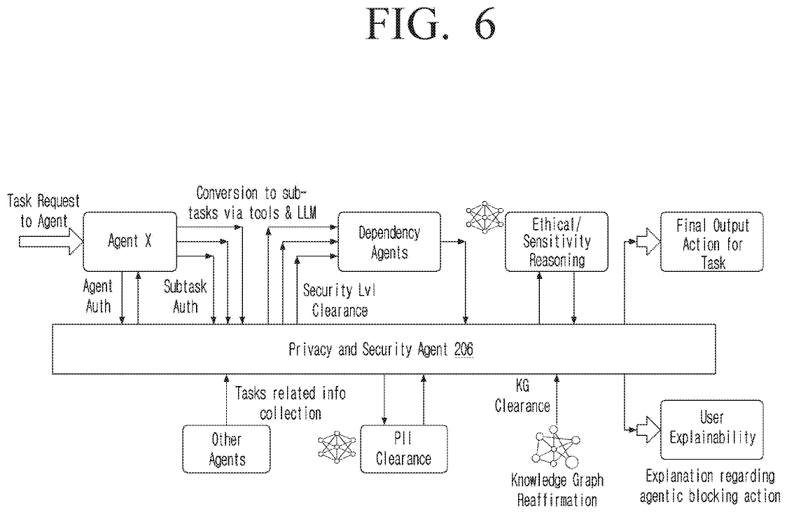

FIG. 6 illustrates a flow diagram of a task execution flow performed by a privacy and security agent according to an embodiment of the disclosure.

Referring to FIG. 6, first step includes the agent authentication. When an agent, for example agent X, receives a particular task, the agent monitoring module 108 authenticates the agent X with the privacy and security agent 206 via a ZKP protocol to ensure that the agent X is reliable and not corrupted/unauthorized. After the agent X is mutually authenticated, a secure communication channel is created for further processing.

After authentication, the agent X proceeds with the task, and converts the given task into sub-tasks so that the agent X can use the available tools, extensions and functions properly. Each sub-task is also authenticated by the privacy and security agent 206 by correlating the sub-task objective with the resources, accesses, data, tools, extensions, and so on being used by the agent for its execution.

For the purpose of sub-task authentication, the privacy and security agent 206 collaborates with other authenticated on-device agents to get required information for authentication. Agents, such as the contextual awareness agent 224, data aggregation and analytics agent 220, task automation agent 214, and so on share requisite information with respect to the sub-task which helps the privacy and security agent 206 in authenticating the sub-task.

Further security levels are assigned whenever a new agent is introduced. The levels depend on the criticality of the task being performed. If an agent having a lower security level tries to access critical information, such as user's private data, gallery, and so on, then that is deemed as improper access by the privacy and security agent 206. The ZKP computation complexity for proofs varies as per the security levels. Hence, lower security clearance levelled agents which do not access critical resources need not have computationally intensive authentication.

The output of the sub-task before being sent outside the electronic apparatus 100 or to other agents, and so on, is checked for PII, and is confirmed that if the PII info is absolutely necessary, only then the output is allowed. This stage ensures that for irrelevant cases or inadvertent sharing/leakage cases, PII sharing is blocked from being forwarded, specially outside the electronic apparatus 100.

The agent monitoring module 108 also provides ethical and sensitive thought reasoning which can decide on the usage of data with respect to ethical and sensitivity usage on top of previously checked authorization and PII clearance. The thought reasoning model analyzes the sub-task to be done, resource accessed by the agent X and the output shared, to ensure compliance of ethical and sensitivity usage. For example, an agent preparing a collage of a person may automatically access gallery images with face of the user, but with thought reasoning step, private or personal images of the user can be separated from being used. Similarly, credit card info, and any other identification info images can also be blocked in time from being uploaded anywhere.

The on-device knowledge graph for agentic monitoring consists of information related to security vulnerabilities, domain specific information, and external accesses misuse info, and so on. This helps to check and validate the task output, and reaffirm that the obtained output has cleared all parameters and the agents have followed all rules.

After all the steps, such as authentication, security level clearances, PII clearances, thought reasoning, knowledge graph Reaffirmation, and so on, the output/task action is cleared and can be executed or shared to the user. If an agentic task/sub-task fails in any of the above steps, the user may not know about the task/sub-task failure, and many of the tasks might be created/automated in the backend without user's explicit awareness. Hence, via user explainability, the agent monitoring module 108 explains to the user about any agentic task which failed and the reasoning behind its failure. This helps the user in understanding what is happening on his device, as well as manually restarting any tasks which might have been blocked but the user needs it to be done in an alternate way, for example regarding automated payments or taking any steps for agents as suitable for the user.

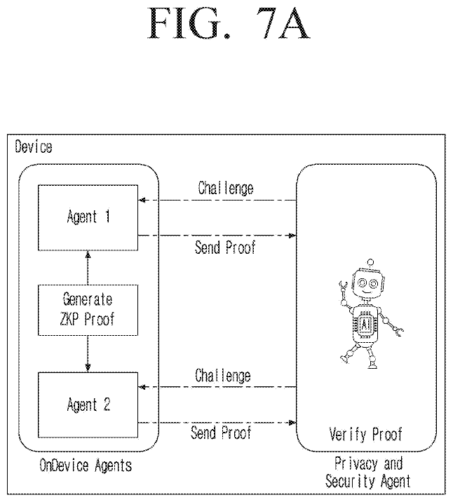

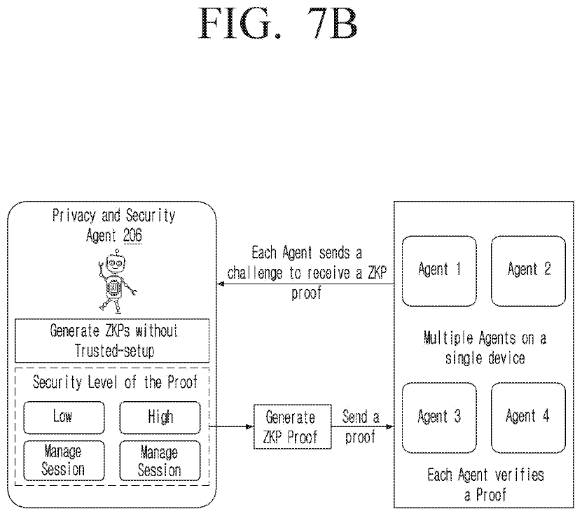

FIG. 7A illustrates a process for ZKP authentication according to an embodiment of the disclosure. The figure shows the mutual authentication process between the privacy and security agent 206 and other agents.

FIG. 7B illustrates operations for agent authentication, including generation of proofs without trusted setup, varying security setup levels, and so on according to an embodiment of the disclosure.

Referring to FIGS. 7A and 7B, the agent authentication via ZKP ensures mutual authentication between agents and agent integrity is intact before any other interaction. The privacy and security agent 206 ensures that other agents comply with privacy policies without knowing any specifics of the data, or the user interactions complies with privacy policies without knowing any specifics of the data or the user interactions. Agents can prove that they have the correct access control tokens or permissions without revealing these tokens. ZKP ensures that information need not be shared before authentication and secure channel is established.

The privacy and security agent 206 is in charge of all authentications as the privacy and security agent 206 is a highest privileged agent. The ZKP authentication protects against agent impersonation, and sensitive data never shared without secure channel establishment.

The privacy and security agent 206 uses ZKPs without zero-knowledge succinct non-interactive argument of knowledge (zk-SNARKs), and no trusted set-up involvement or requirement. The privacy and security agent 206 uses crypto proofs without requiring a trusted setup. The privacy and security agent 206 verifies the security level against the task accesses done. The privacy and security agent 206 adjusts the level of complexity for proofs based on above security needs. The privacy and security agent 206 manages session lifetime, and proof expiration based using AI agent.

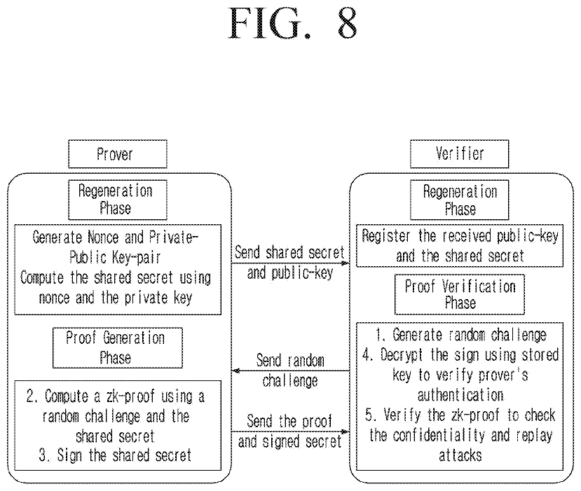

FIG. 8 illustrates a proposed ZKP System without trusted-setup according to an embodiment of the disclosure.

Referring to FIG. 8, the ZKP System without trusted-setup comprises an AI agent as a prover, and the privacy and security agent 206 as a verifier. The prover comprises a regeneration phase, and a proof generation phase. The verifier comprises a regeneration phase, and a proof verification phase. The prover generates nonce, and private-public key-pair, and computes the shared secret using nonce and the private key, in the regeneration phase. The prover sends shared secret, and public-key to the verifier. The verifier registers the received public-key, and the shared secret in the regeneration phase. The verifier generates a random challenge in the proof verification phase, and sends the random challenge to the prover. The prover computes a zk-proof using the random challenge and the shared secret, and signs the shared secret in the proof generation phase. The prover sends the proof and signed secret to the verifier. The verifier decrypts the sign using stored key to verify prover's authentication, and verifies the zk-proof to check the confidentiality and replay attacks in the proof verification phase.

Table 1 indicates ZKP protocol details.

TABLE 1

| | | Privacy & Security |
|---|---|---|
| Phase | AI Agent (Prover) | Agent (Verifier) |
| Registration phase | Generate secret (SKa) and | Register app's Ha and |
| | public key (PKa) for each | corresponding Public |
| | agent. | key (PKa) |
| | Ha = H(app's secret code) | |
| | Share agent's hashed secret | |
| | Ha and public key (PKa) | |
| | with the P&S Agent. | |
| Proof generation & | Step 2: Compute: | Step 1: Send random |
| verification | C = H(Ha∥S∥R) | challenge S to the agent. |
| phase | Step 3: Generate signature | Step 5: Receive the |
| | (sign) for Ha using Agent's | proof = {C, sign, R} |
| | secret key. | and decrypt the sign |
| | Sign = ESKa(Ha) | using stored public |
| | Step 4: Mobile agent sends | key to ensure the |
| | the proof = {C, sign, R} | agent's authentication: |
| | to the security & | DPKa(sign) = true?; If it |
| | privacy agent. | holds, agent's |
| | | authenticity is ensured. |
| | | Step 6: Retrieve S, Ha |
| | | and Compute: |
| | | C′ = H(Ha∥S∥R) |
| | | Compare C′ = C? |
| | | If it holds, agent's |
| | | integrity is verified |

The notations in the Table 1 includes:
SKa—Secret Key of the agent
PKa—Public key of the agent, which is shared with the verifier
Ha—Hash of the agent's secret code
S—Random challenge sent by the verifier
R—Random nonce of the prover to prevent reply attacks
H(.)—Hash Function
C—Commitment

The advantages of the ZKP Protocol include:
No trusted setup—eliminates dependency on a trusted setup, avoiding security risks, such as toxic waste, unlike zk-SNARKs.
Nonce-based security—prevents replay and man-in-the-middle attacks by integrating a nonce, enhancing resistance against fraudulent proof reuse.
Minimal computational overhead—avoids expensive elliptic curve pairings, making it significantly faster and energy-efficient for smart devices.
Optimized for mobile and Internet of things (IoT)—designed for low-power environments, ensuring efficient proof generation and verification on resource-constrained devices.
Manage security levels—adjusts the level of complexity for proofs based on above security needs.
Manage sessions—manages session lifetime and proof expiration based using AI agent.

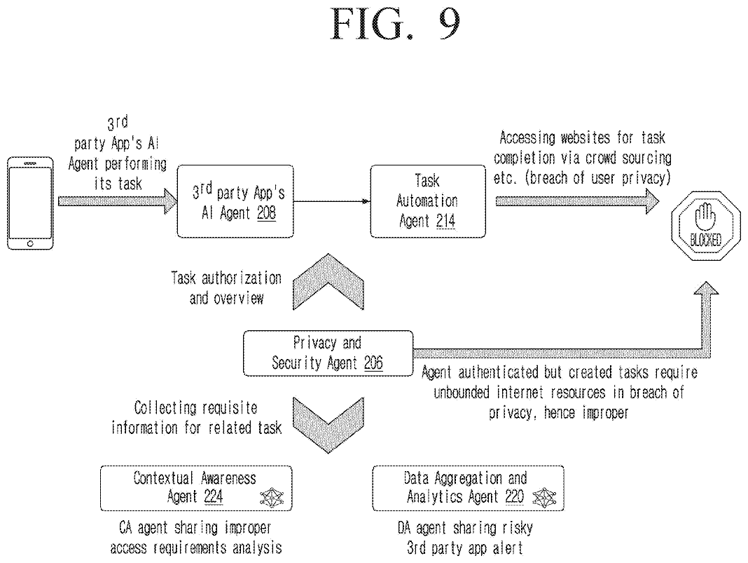

FIG. 9 illustrates a use case of an agent unbounded internet resource access according to an embodiment of the disclosure.

Referring to FIG. 9, when a 3^{rd} party app's AI agent or 3^{rd} party add-on agents 208 is performing its task, the task automation agent 214 may try to access websites for task completion via crowd sourcing, or the like, (breach of user privacy). The privacy and security agent 206 verifies task authorization and overview, and collects requisite information for related task. The contextual awareness agent 224 shares improper access requirements analysis with the privacy and security agent 206. The data aggregation and analytics agent 220 shares risky 3rd party app alert with the privacy and security agent 206. The privacy and security agent 206 analyzes and blocks accessing websites for task completion, indicating as the agent authenticated but created tasks require unbounded internet resources in breach of privacy, hence improper.

Any on-device AI Agent, if performing any task, has access to lot of resources to complete the task. The proposed method 300 can detect if the agent is going out of bounds and accessing permissions/resources which may breach of privacy, then such an action/task can get blocked. For example, accessing internet and sharing information to crowd sourcing websites is breach of user privacy, hence gets blocked by the privacy and security agent 206 after taking requisite information from other agents.

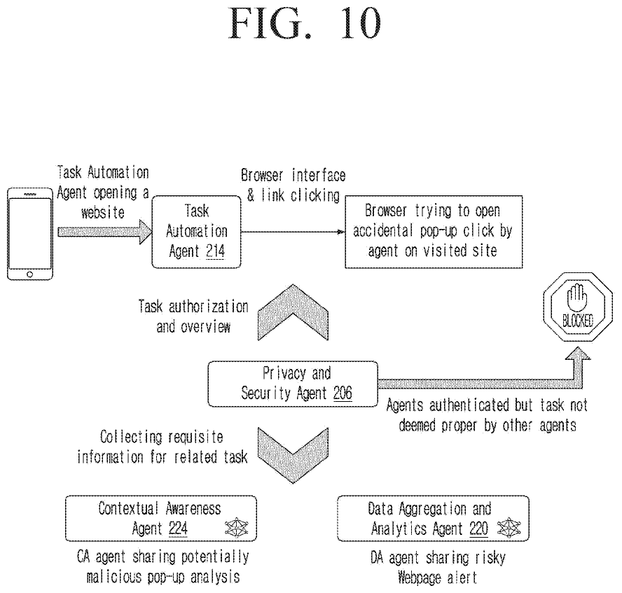

FIG. 10 illustrates a use case of a situation based pop-up attack blocking according to an embodiment of the disclosure.

Referring to FIG. 10, the task automation agent 214 if trying to open an external website might inadvertently open any pop-up link also. This is deemed as improper clicking action by the privacy and security agent 206 after collection info from other agents, and hence gets blocked.

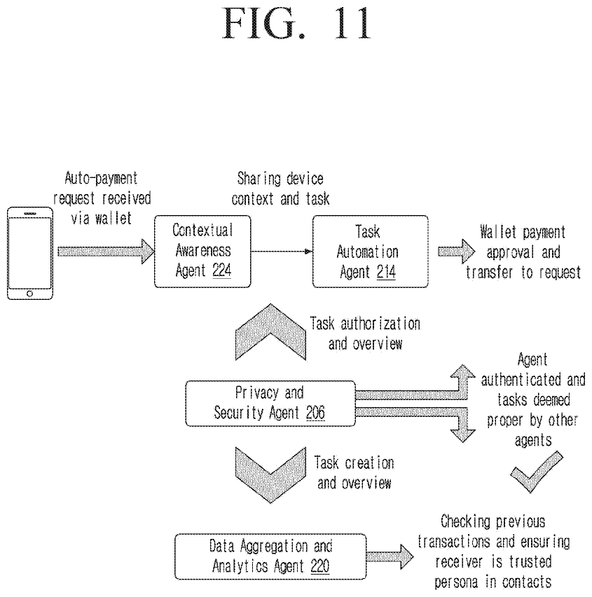

FIG. 11 illustrates a use case of an agentic interaction for auto-payment according to an embodiment of the disclosure.

Referring to FIG. 10, an auto-payment request process if coming from a known persona, and the privacy and security agent 206 checking its previous transaction history, may allow the agents responsible for it (namely contextual awareness agent 224, and the task automation agent 214) to proceed with the task. For marking this task as a proper access, the privacy and security agent 206 takes information from the data aggregation and analytics agent 220 to obtain persona info as well as previous transaction history.

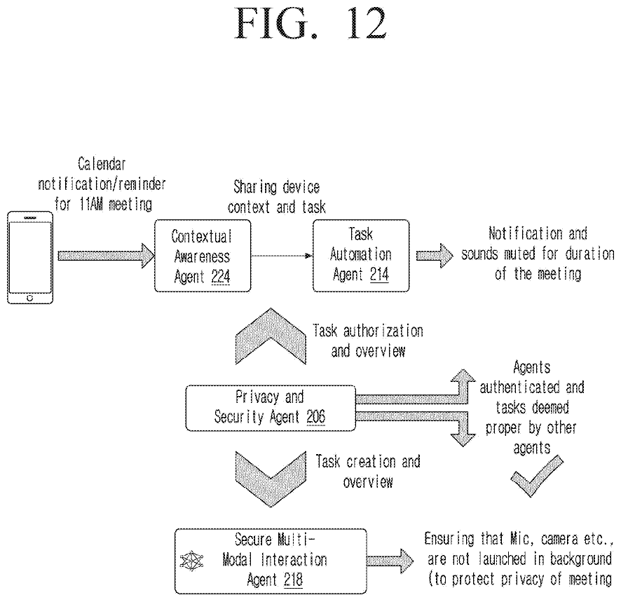

FIG. 12 illustrates a use case of a situation based agent co-ordination according to an embodiment of the disclosure.

Referring to FIG. 12, when a calendar notification/reminder for 11 AM meeting is triggered, the contextual awareness agent 224 shares device context and task. The privacy and security agent 206 verifies task authorization and overview, and performs task creation and overview. The secure multi-modal interaction agent 218 ensures that microphone, camera, and so on, are not launched in background (to protect privacy of meeting), and share information with the privacy and security agent 206. The privacy and security agent 206 indicates as the agents authenticated, and tasks deemed proper by other agents. The task automation agent 214 provides notification and sounds muted for duration of the meeting.

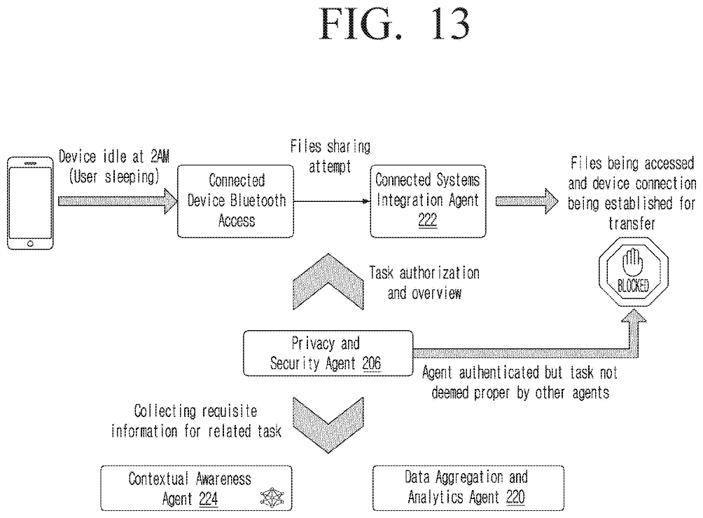

FIG. 13 illustrates a use case of a situation based agent authentication and blocking according to an embodiment of the disclosure.

Referring to FIG. 13, a file sharing attempt via connected systems agent is initiated, but when the electronic apparatus 100 has been idle for a long time (user asleep scenario) gets flagged as disallowed by the privacy and security agent 206 after getting and analyzing the information available via other agents. The privacy and security agent 206 concludes that even though the responsible agent is authenticated, but the incoming request is not valid considering that the electronic apparatus 100 is idle and user is presumed asleep, so the user cannot initiate Bluetooth transfer request.

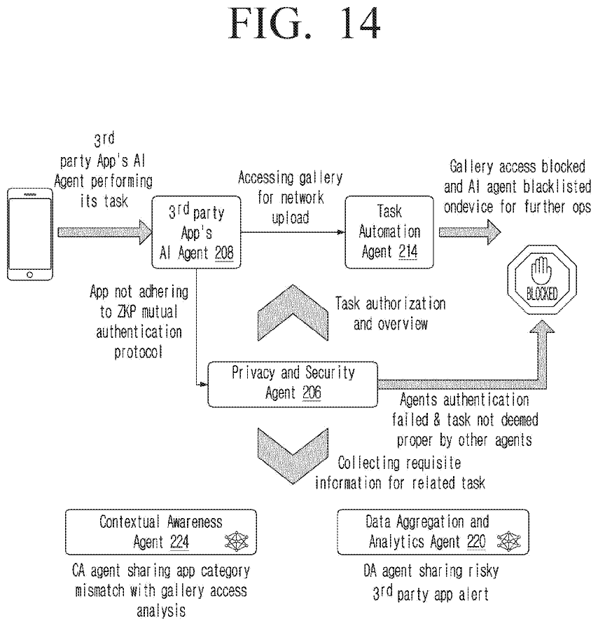

FIG. 14 illustrates a use case of an agent authentication failure according to an embodiment of the disclosure.

Referring to FIG. 14, when a 3^{rd} party App's AI agent performing its task, the 3^{rd} party App's AI agent 208 accesses gallery for network upload. The privacy and security agent 206 verifies task authorization and overview, and collects requisite information for related task. The privacy and security agent 206 also receives that the App not adhering to ZKP mutual authentication protocol, from the 3rd party App's AI agent 208. The contextual awareness agent 224 shares app category mismatch with gallery access analysis. The data aggregation and analytics agent 220 shares risky 3rd party app alert. The privacy and security agent 206 indicates as agents authentication failed and task not deemed proper by other agents. The task automation agent 214 blocks the gallery access, and AI agent is blacklisted on-device for further operations.

The method 300 is a real-time system for safeguarding the security and privacy of a user's data and device by the agent monitoring module 108, and the privacy and security agent 206 by providing authorized agentic access, PII cleared data transfers, knowledge graph based task outputs, user explainability, and ethical/sensitivity reasoning. The agent monitoring module 108, and the privacy and security agent 206. The method 300 uses a combination of security mechanisms, AI agents, LLM models, PII Models, and so on.

The method 300 has agentic monitoring with security clearance checking by assigning security levels to different agents. The method 300 also checks for PII clearances to ensure that no personal information is used wherever unnecessary, or that personal information not exposed to external components. The task output involves reaffirmation with knowledge graph to ensure correct output and user explainability in-case of blocked agentic actions.

Therefore, user's data and privacy always remains protected on the device due to privacy and security agent's monitoring. Any action taken by agents is always authenticated and monitored by the privacy and security agent 206, and gets blocked if authentication of agent has failed or if the privacy and security agent 206 deems that the action being undertaken is not proper. This provides a multi-auth protection for the user. The monitoring is implemented in the backend without any user interaction requirement, or without user prompting. The agent monitoring ensures smooth transfer of information, actions and interactions between the agents. AI agents remember and learn from past transactions, and behavior history, and can automate such transactions for the user without the user having to explicitly initiate them. The privacy and security agent 206 provides PII cleared output along with knowledge graph based output reaffirmation, so the user can be sure that his/her personal data was not leaked and the agent's output is monitored and is proper. The privacy and security agent 206 further capable of monitoring the LLM model's behavior to detect anomalies or signs of manipulation. The privacy and security agent 206 provides user explainability in case of any blocked agentic actions, so the user is always aware of what is happening on his/her device.

The method 300 is easily scalable to different edge devices, such as smartphones, tabs, smartwatches, TV, and so on, as the method 300 is platform agnostic, and can also cover family of devices via shared monitoring, to proactively keep family of devices safe if any one violation instance is found on a particular device. The method 300 can also be implemented for other devices, such as PCs, laptops, and so on, and specially for governmental organizations wherein security and privacy of company data is a vital component along with user's privacy. The method 300 can also cover smart/connected cars, and self-driving cars ecosystem for ensuring continued protection for the user on-the-go. The method 300 can also be expanded for smart factories which automate production using smart system and AI agents.

The embodiments disclosed herein can be implemented through at least one software program running on at least one hardware device. The modules shown in FIG. 1 include blocks which can be at least one of a hardware device, or a combination of hardware device and software module.

The embodiment disclosed herein describes an electronic apparatus 100 and methods 300 for security and privacy preserving agentic monitoring in edge devices. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., very high speed integrated circuit hardware description language (VHDL) another programming language, or implemented by one or more VHDL or several software modules being executed on at least one hardware device. The hardware device can be any kind of portable device that can be programmed. The device may also include means which could be e.g., hardware means like e.g., an application-specific integrated circuit (ASIC), or a combination of hardware and software means, e.g., an ASIC and a field programmable gate array (FPGA), or at least one microprocessor and at least one memory with software modules located therein. The method embodiments described herein could be implemented partly in hardware and partly in software. Alternatively, the disclosure may be implemented on different hardware devices, e.g., using a plurality of CPUs.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for managing privacy and security in an edge device, the method comprising:
collecting, by an agent monitoring module of an electronic apparatus, at least one of context and data related to at least one of the electronic apparatus, and one or more devices connected to the electronic apparatus;
monitoring, by the agent monitoring module, at least one task being performed by at least one agent;
allocating, by the agent monitoring module, one or more tasks to a plurality of agents based on at least one of the collected at least one of context and data, and the at least one monitored task being performed by the at least one agent; and
connecting, by the agent monitoring module, a privacy and security agent with the plurality of agents for performing the one or more allocated tasks of the electronic apparatus,
wherein the privacy and security agent is configured to:
interact with the plurality of agents for performing at least one of an agent authentication, a task authentication, a security level clearance, a personal identifiable information (PII) clearance, a thought reasoning, a knowledge graph reaffirmation, and a user explainability for the one or more tasks to be executed with privacy and security.

2. The method of claim 1,
wherein the context of the at least one of the electronic apparatus, and one or more devices connected to the electronic apparatus is collected from at least one of multimodal activities, an application behaviour, a user behaviour, and a connected devices interaction, and
wherein the data of the at least one of the electronic apparatus, and one or more devices connected to the electronic apparatus comprises at least one of permission, usage stats, resources stats, network stats, accessibility stats, and device security.

3. The method of claim 1, further comprising:
separating, by the agent monitoring module, the privacy and security agent, and the plurality of agents into one or more levels based on at least one of criticality, and functionality of the one or more tasks being performed.

4. The method of claim 1, wherein the plurality of agents comprise at least one of a data aggregation and analytics agent, a secure multi-modal interaction agent, a connected systems integration agent, a contextual awareness agent, a resource optimization agent, a task automation agent, a health and wellness agent, and one or more customizable/add-on agents.

5. The method of claim 1, further comprising:
authenticating the at least one agent through a zero-knowledge proof (ZKP) protocol for performing the agent authentication, on receiving at least one task corresponding to the at least one agent, wherein the ZKP protocol is configured to use crypto proofs for allowing the plurality of agents to adjust a level of complexity for one or more ZK proofs based on one or more security levels, and managing a session lifetime and ZK proof expiration using an artificial intelligence (AI) agent;
authenticating one or more sub-tasks for performing the task authentication, after authenticating the at least one agent, wherein the at least one agent that is responsible for the at least one task can convert the at least one task into the one or more sub-tasks;
verifying a security level of the at least one authenticated agent for performing the security level clearance for the at least one task, and confirming if the at least one authenticated agent has the security level clearance for performing the at least one task, wherein the one or more security levels are assigned for each agent by the agent monitoring module depending on criticality of the at least one task being performed for blocking the at least one agent with a lower security level from accessing critical information;
verifying the PII clearance of each sub-task before sending output of each sub-task to at least one of outside of the electronic apparatus, and next sub-task and the plurality of agents on the electronic apparatus, wherein the output of each sub-task is allowed when the PII is verified as necessary;
deciding on usage of data related to ethical and sensitivity usage of the at least one authenticated agent, and the verified PII clearance, using a thought reasoning model;
validating, and reaffirming the output of each sub-task using an on-device knowledge graph after deciding on usage of data related to ethical and sensitivity usage, wherein the on-device knowledge graph comprises at least one of information related to security vulnerabilities, domain specific information, and external accesses misuse information; and
executing and sharing the validated and reaffirmed output to the user.

6. The method of claim 5, wherein the method of authenticating the one or more sub-tasks, comprises:
collaborating, by the privacy and security agent, with one or more authenticated agents for obtaining information related to the one or more sub-tasks, wherein the information related to the one or more sub-tasks comprises at least one of resources, accesses, data, tools, and extensions being used by the plurality of agents for execution;
correlating, by the privacy and security agent, objective of each sub-task with the obtained information related to the one or more sub-tasks; and
authenticating, by the privacy and security agent, the one or more sub-tasks based on the correlated objective of each sub-task.

7. The method of claim 1, wherein the privacy and security agent is configured to perform the user explainability by explaining to a user on one or more failed tasks, and one or more reasons for the one or more failed tasks.

8. An electronic apparatus comprising:
at least one processor;
memory, comprising one or more storage media, storing instructions; and
an agent monitoring module communicatively coupled to the at least one processor and the memory,
wherein the instructions, when executed by the at least one processor individually or collectively, cause the electronic apparatus to:
collect at least one of context and data related to at least one of the electronic apparatus, and one or more devices connected to the electronic apparatus,
monitor at least one task being performed by at least one agent,
allocate one or more tasks to a plurality of agents based on at least one of the collected at least one of context and data, and the at least one monitored task being performed by the at least one agent, and
connect a privacy and security agent with the plurality of agents for performing the one or more allocated tasks of the electronic apparatus,
wherein the privacy and security agent is configured to:
interact with the plurality of agents for performing at least one of an agent authentication, a task authentication, a security level clearance, a personal identifiable information (PII) clearance, a thought reasoning, a knowledge graph reaffirmation, and a user explainability for the one or more tasks to be executed with privacy and security.

9. The electronic apparatus of claim 8,
wherein the context of the at least one of the electronic apparatus, and one or more devices connected to the electronic apparatus is collected from at least one of multimodal activities, an application behaviour, a user behaviour, and a connected devices interaction, and
wherein the data of the at least one of the electronic apparatus, and one or more devices connected to the electronic apparatus comprises at least one of permission, usage stats, resources stats, network stats, accessibility stats, and device security.

10. The electronic apparatus of claim 8, wherein the instructions, when executed by the at least one processor individually or collectively, further cause the electronic apparatus to separate the privacy and security agent, and the plurality of agents into one or more levels based on at least one of criticality, and functionality of the one or more tasks being performed.

11. The electronic apparatus of claim 8, wherein the plurality of agents comprise at least one of a data aggregation and analytics agent, a secure multi-modal interaction agent, a connected systems integration agent, a contextual awareness agent, a resource optimization agent, a task automation agent, a health and wellness agent, and one or more customizable/add-on agents.

12. The electronic apparatus of claim 8, wherein the instructions, when executed by the at least one processor individually or collectively, further cause the electronic apparatus to:
authenticate the at least one agent through a zero-knowledge proof (ZKP) protocol for performing the agent authentication, on receiving at least one task corresponding to the at least one agent, wherein the ZKP protocol is configured to use crypto proofs for allowing the plurality of agents to adjust a level of complexity for one or more ZK proofs based on one or more security levels, and manage a session lifetime and ZK proof expiration using an artificial intelligence (AI) agent,
authenticate one or more sub-tasks for performing the task authentication, after authenticating the at least one agent, wherein the at least one agent that is responsible for the at least one task can convert the at least one task into the one or more sub-tasks,
verify a security level of the at least one authenticated agent for performing the security level clearance for the at least one task, and confirm if the at least one authenticated agent has the security level clearance for performing the at least one task, wherein the one or more security levels are assigned for each agent by the agent monitoring module depending on criticality of the at least one task being performed for blocking the at least one agent with a lower security level from accessing critical information,
verify the PII clearance of each sub-task before sending output of each sub-task to at least one of outside of the electronic apparatus, and next sub-task and the plurality of agents on the electronic apparatus, wherein the output of each sub-task is allowed when the PII is verified as necessary,
decide on usage of data related to ethical and sensitivity usage of the at least one authenticated agent, and the verified PII clearance, using a thought reasoning model,
validate, and reaffirm the output of each sub-task using an on-device knowledge graph after deciding on usage of data related to ethical and sensitivity usage, wherein the on-device knowledge graph comprises at least one of information related to security vulnerabilities, domain specific information, and external accesses misuse information, and
execute and share the validated and reaffirmed output to the user.

13. The electronic apparatus of claim 12, wherein the instructions, when executed by the at least one processor individually or collectively, further cause the electronic apparatus to:
collaborate with one or more authenticated agents for obtaining information related to the one or more sub-tasks, wherein the information related to the one or more sub-tasks comprises at least one of resources, accesses, data, tools, and extensions being used by the plurality of agents for execution,
correlate objective of each sub-task with the obtained information related to the one or more sub-tasks, and
authenticate the one or more sub-tasks based on the correlated objective of each sub-task.

14. The electronic apparatus of claim 10, wherein the instructions, when executed by the at least one processor individually or collectively, further cause the electronic apparatus to perform the user explainability by explaining to a user on one or more failed tasks, and one or more reasons for the one or more failed tasks.

15. One or more non-transitory computer-readable storage media storing one or more computer programs including computer-executable instructions that, when executed by at least one processor of an audio output apparatus individually or collectively, cause the audio output apparatus to perform operations, the operations comprising:
collecting, by an agent monitoring module of an electronic apparatus, at least one of context and data related to at least one of the electronic apparatus, and one or more devices connected to the electronic apparatus;
monitoring, by the agent monitoring module, at least one task being performed by at least one agent;
allocating, by the agent monitoring module, one or more tasks to a plurality of agents based on at least one of the collected at least one of context and data, and the at least one monitored task being performed by the at least one agent; and
connecting, by the agent monitoring module, a privacy and security agent with the plurality of agents for performing the one or more allocated tasks of the electronic apparatus,
wherein the privacy and security agent is configured to:
interact with the plurality of agents for performing at least one of an agent authentication, a task authentication, a security level clearance, a personal identifiable information (PII) clearance, a thought reasoning, a knowledge graph reaffirmation, and a user explainability for the one or more tasks to be executed with privacy and security.

16. The one or more non-transitory computer-readable storage media of claim 15,
wherein the context of the at least one of the electronic apparatus, and one or more devices connected to the electronic apparatus is collected from at least one of multimodal activities, an application behaviour, a user behaviour, and a connected devices interaction, and
wherein the data of the at least one of the electronic apparatus, and one or more devices connected to the electronic apparatus comprises at least one of permission, usage stats, resources stats, network stats, accessibility stats, and device security.

17. The one or more non-transitory computer-readable storage media of claim 15, the operations further comprising:
separating, by the agent monitoring module, the privacy and security agent, and the plurality of agents into one or more levels based on at least one of criticality, and functionality of the one or more tasks being performed.

18. The one or more non-transitory computer-readable storage media of claim 15, wherein the plurality of agents comprise at least one of a data aggregation and analytics agent, a secure multi-modal interaction agent, a connected systems integration agent, a contextual awareness agent, a resource optimization agent, a task automation agent, a health and wellness agent, and one or more customizable/add-on agents.

19. The one or more non-transitory computer-readable storage media of claim 15, the operations further comprising:
authenticating the at least one agent through a zero-knowledge proof (ZKP) protocol for performing the agent authentication, on receiving at least one task corresponding to the at least one agent, wherein the ZKP protocol is configured to use crypto proofs for allowing the plurality of agents to adjust a level of complexity for one or more ZK proofs based on one or more security levels, and managing a session lifetime and ZK proof expiration using an artificial intelligence (AI) agent;
authenticating one or more sub-tasks for performing the task authentication, after authenticating the at least one agent, wherein the at least one agent that is responsible for the at least one task can convert the at least one task into the one or more sub-tasks;
verifying a security level of the at least one authenticated agent for performing the security level clearance for the at least one task, and confirming if the at least one authenticated agent has the security level clearance for performing the at least one task, wherein the one or more security levels are assigned for each agent by the agent monitoring module depending on criticality of the at least one task being performed for blocking the at least one agent with a lower security level from accessing critical information;
verifying the PII clearance of each sub-task before sending output of each sub-task to at least one of outside of the electronic apparatus, and next sub-task and the plurality of agents on the electronic apparatus, wherein the output of each sub-task is allowed when the PII is verified as necessary;
deciding on usage of data related to ethical and sensitivity usage of the at least one authenticated agent, and the verified PII clearance, using a thought reasoning model;
validating, and reaffirming the output of each sub-task using an on-device knowledge graph after deciding on usage of data related to ethical and sensitivity usage, wherein the on-device knowledge graph comprises at least one of information related to security vulnerabilities, domain specific information, and external accesses misuse information; and
executing and sharing the validated and reaffirmed output to the user.

20. The one or more non-transitory computer-readable storage media of claim 19, the operations further comprising:
collaborating, by the privacy and security agent, with one or more authenticated agents for obtaining information related to the one or more sub-tasks, wherein the information related to the one or more sub-tasks comprises at least one of resources, accesses, data, tools, and extensions being used by the plurality of agents for execution;
correlating, by the privacy and security agent, objective of each sub-task with the obtained information related to the one or more sub-tasks; and
authenticating, by the privacy and security agent, the one or more sub-tasks based on the correlated objective of each sub-task.
